(19) United States
(12) Patent Application Publication
(10) Pub. No.: US 2013/0005200 A1
(43) Pub. Date: Jan. 3, 2013

(54) Methods of pulsed nuclear energy generation using piston-based systems

(75) Inventor: Anatoly L. Mayburd, Alexandria, VA (US)

(73) Assignee: Anatoly Mayburd, Alexandria, VA (US)

(21) Appl. No.: 13/067,798

(22) Filed: Jun. 28, 2011

(51) Int. Cl. B63H 1/00; F02G 1/055; B63B 1/34

(52) U.S. Cl. 440/18; 60/517

(57) ABSTRACT

The invention describes a method of nuclear energy transformation into electric and/or mechanical energy by triggering criticality in a working cylinder by an approach of a piston with a neutron reflector layer to fissile heat elements. Optionally, liquid moderator should fill the heating element to provide for an additional condition of such triggering. The pulse reaction initiates a heat cycle by expanding working fluid, extracting mechanical work and compressing the working fluid using lower amount of energy. The energy released in reaction can drive a column of water as a liquid piston propelling a highly efficient hydraulic turbine and producing a simple economical method of energy conversion. The piston movements can also be converted in laser and electromagnetic pulses. Self-regulation of nuclear reaction by a reflector piston linked to a resilient spring can be used in marine propulsion. In one method, the approach of the reflector piston triggers a reaction that evaporates water in the pressure chamber and produces a reactive thrust in a noozle. A fraction of the steam is diverted to produce steam bubble envelope on the surface of the vessel to minimize drag. Another fraction of the diverted steam drives a pump, pumping sea water into the heating elements. Other practical and novel applications of the method are disclosed.

### FEDERALLY SPONSORED RESEARCH

not applicable

### SEQUENCE LISTING OR PROGRAM

not applicable\

### FIELD OF INVENTION

This invention belongs to the field of peaceful nuclear energy conversion and introduces novel engines operating on nuclear energy.

### BACKGROUND

A group of technological processes and human activities was always important and gains even more significance recently: mining of mineral riches and fossil fuels, mining production of non-oil fossil fuels, drilling exploration of sea bed, ground drilling operations on dry surface, sea water desalination, fluid pumping, general energy production, marine, river and rail propulsion, non-rail propulsion on dry surface, space propulsion, unmanned flight, residential heating, energy provision of military bases, pulse production of energy for lasers, pulse production of energy for particle accelerators, pulse production of energy for charging super-capacitors.

Under many circumstance performing these operations efficiently requires a consistent source of power: solar, nuclear or taken from electric grid. Under many circumstance such source of power can only be nuclear, for example for deep and mobile underground or submersible facilities.

More generally, regular energy production using nuclear power requires a reform to improve safety, costs per unit of energy produced, power-to-weight ratio and flexibility. A small, simply designed, thermodynamically efficient, rugged reactor capable of fine-tuning its energy production within a broad range and capable of controlled bursts of power within a fracture of a second is a welcome development for many existing fields of industry and for the emerging one.

The current nuclear power systems are exclusively based on turbines as the means to transform the heat of fissile reactions into useful forms of energy. Turbine-based operations produce a constant energy output and stationary regime of equipment functioning. These properties have many advantages, known to the skilled in the art. The disadvantages of stationary turbine cycles are the following: thermodynamic efficiency is limited by the properties of working fluids and construction materials, the minimal equipment of a traditional Rankin cycle comprises a boiler, a turbine, a generator, a condenser and a circulation pump and in combination this equipment is heavy. It also involves additional heat dissipation. Turbine cycles are often nested and the bottom cycle require water source for cooling. This requirement forces construction of nuclear energy plants on the sea coasts and river banks and makes them water dependent. Obviously, nested cycles allow using reactor types of higher thermodynamic efficiency at the price of higher equipment costs and heat waste in the massive equipment. Turbine-based cycles are incapable of producing rapid controlled variations in the output power and any variations are limited by high thermal and kinematic inertia in the system.

Pulsed piston-based methods of energy transformation is the most widely used method at small and medium scale, embodied in Otto and Diesel cycles used in internal combustion engines (ICE). One benefit of such engines is high thermodynamic efficiency achieved by rapid and transient compression of working fluid to high pressure and temperature. Transient character of this initial stage means that the thermal decomposition and construction deformation is of minimal duration and allows higher Carnot efficiencies. Similar properties are expected for pulsed piston-based engines based on nuclear energy utilization. The piston engines are compact and allow rapid start-up and variation in power output in the broadest range. Stopping and re-starting such engines is much easier as compared to turbines, especially considering the use of nuclear power. While in fossil-fuel based engines the individual detonation pulses are smoothed by using multiple cylinders, in the context of using nuclear energy these pulses can be used individually and not only the smoothed cumulative energy product of these pulses. The convenience of using cylinders is in the desired range of velocities of moving parts. Turbine use relies on utilization of reaction forces arising during interaction with the stream of working fluid and an efficient turbine regime is linked to the working fluid stream velocity. By contrast, the velocities observed in piston engines can be regulated by the selection of piston's effective mass (resistive force). The piston-based designs can connect all elements of a cycle, including a condenser in a single compact body, increasing a potential power-to weight ratio.

The list of differences between turbines and piston cylinders as means of energy conversion can be continued and it is obvious that use of cylinders is advantageous under many circumstances. However, based on our study of the question no satisfactory technical approaches were developed so far to enable use of nuclear energy in piston cylinders in a practical, technologically feasible fashion. This conclusion summarizes a review of the unsuccessful attempts to accomplish this goal.

U.S. Pat. No. 3,549,490 to Richard L. Moore and a related patent publication GB1249430 by the same inventor disclose a reciprocating type of motor which is directly driven by the power of a nuclear reactor. A piston is reciprocally mounted in a frame. One end of the piston is exposed to a reservoir containing a solution of nuclear fuel and the other end of the piston is connected to a reciprocating power take-off. When a fission chain reaction takes place in the nuclear fuel, part of the fluid flashes into steam and the volume of a container in which the solution is placed expands, driving the piston outwardly against tension of a return device, as for example a spring. At the same time that the volume of the container expands, the energy generated in the solution diminishes. When the piston reaches the outer end of its stroke, the creation of energy diminishes to a point where the piston returns by action of the return device causing a reduction of the volume of the container, whereupon the rate at which the nuclear fuel generates energy is then increased causing another reciprocation of the piston. The invention discloses and claims boiling of U235 fuel water solution as a working system and relies on control rods to impact the reaction rate. Use of homogenous solutions of enriched fissile materials as working fluid directly is not practical from safety and material corrosion point of view, especially considering high temperature and dynamic mode of functioning. While the claim 1 of the invention apparently discusses a moderator in general, not only water, it is the homogenous mixing of the fissile material and working fluid of any nature that is problematic from engineering/safety point of view. Use of control rods to deal with peak intensities implies instant feedback time that may not be available in this highly dynamic system, especially considering the embodiments comprising enriched U235. Thus, this invention does not solve the problem of a safe, compact, economical piston-based system of nuclear energy harvesting.

A non-patent reference titled “A nuclear engine design with ^{242m}Am as a nuclear fuel” in Annals of Nuclear Energy, Volume 27, Issue 1, January 2000, Pages 85-91 by Y. Ronen, M. Aboudy and D. Regev presents a preliminary design for a nuclear engine. The engine is based on the nuclear heating of a gas composed of H2 and ^{242m}Am blend (Americium hexafluoride) as a nuclear fuel. This engine has an initial volume of 0.135 m³ and at 64 MPa the critical mass is 0.228 kg. The low critical mass is achieved by a combination of high neutron fissile capture cross-section of ^{242m}Am, high H: Am ratio (1:4000) and beryllium neutron reflector cladding, including walls and piston. The material of the cylinder is a regular construction steel. The engine functions using Otto cycle: the gaseous Am-hydrogen blend is injected in the cylinder, the gas is compressed, criticality is reached due to compression, the reactor gas expands pushing the power piston and producing useful work, the cylinder is cooled and the working fluid is expelled by a reciprocal piston movement. The coolant flow is provided between the steel wall of the cylinder and external beryllium cladding. The publication admits its preliminary character and this can explain the absence of enabling detail. The issues of thermodynamic stability of hexafluoride in the presence of high hydrogen pressure are not addressed, nor was addressed the issue of containment of radioactive hydrogen blend by regular steel at 64 MPa of hydrogen pressure and 400 K temperature. Apparently, the spent Am-hydrogen gas is exhausted, however the processing of the highly radioactive exhausted gas was not considered. The theoretical efficiency of energy conversion was 18%. The project is possible conceptually, but appears to be impractical from the engineering perspective and no enabling details were provided to ensure practicality.

A non-patent reference titled “Inherently safe nuclear-driven internal combustion engines” by Alesso, P. et al. and presented at International conference on emerging nuclear energy systems, Monterey, Calif. (United States), 16-21 Jun. 1991 discloses a family of nuclear driven engines in which nuclear energy released by fissioning of uranium or plutonium in a prompt critical assembly is used to heat a working gas. The assembly comprises a working cylinder, a suspension of uranium oxide dust in helium or hydrogen as a working body, a power piston. As an alternative working fluid the authors propose uranium hexafluoride gas mixed with fluoride or with hydrofluoride as a moderator. Compression of the working body renders the assembly supercritical, the work is extracted and the working body exits for cooling and (at some point) fission products removal. The system is termed “inherently safe” because expansion returns sub-criticality. The project envisages an elaborate technological line of spent fuel treatment. Neutron reflectors are described as a part of construction. The authors admit that “no convenient uranium fuels” exist for their invention and also admit the problem of avoiding piston abrasion by the dispersed solids. Such abrasion will cause progressing inefficiencies (expanding gas leaks) and would make exploitation prohibitively expensive. Using of HF/UF6 blends is likely to be extremely corrosive at the temperatures assumed in the project (2500 K). The project appears to be impractical from the engineering perspective and no enabling details were provided to ensure practicality.

The patent publication U.S. Pat. No. 4,454,850 to Horvath Stephen and Suchiibun Hoobasu discloses and claims an internal combustion type engine, using as a fuel a deuterium containing gas. The gas ionization is primed by oxidative reaction, is enhanced by an electric discharge in the initial plasma and at this point, according to the inventor, nuclear fusion commences providing a source of energy for the heat cycle. Apparently, technical feasibility of such an operation is not demonstrated as of yet. The inventor reports formation of tritium in the system and discloses positive results of testing tracing D-T fusion products. The inventor also discloses higher thermal efficiency of the engine utilizing combustion of hydrogen. Even if hydrogen-fueled engine displays improved energy conversion characteristics, this does not appear to be the consequence of an energy-producing D-T fusion process. According to the current state of the art, such a fusion required special conditions, such as magnetic or inertial confinement and this component is not technically feasible in the context of the inventive technology. The same objections pertaining to technical feasibility also apply to patent publications GB2447947 to Christopher Strevens, relying on controlled fusion within the piston by using transient magnetic confinement. Still another patent publication KR20050098685 to Woo Seung Hoon discloses an internal combustion engine based on hydrogen isotope fusion in the reaction chamber, with the same arguments applying. The publication US2011044416 to Galindo Cabellero et al., describes “a process for controlled nuclear fusion of deuterium atoms that takes place inside a combustion chamber after the combustion of a gaseous fuel that comprises deuterium atoms in the presence of an oxidizing gas and a gaseous catalyst, under positive pressure. It also comprises a controlled nuclear fusion reactor for carrying out the process described, and also the internal combustion engine that comprises the controlled nuclear fusion reactor and a motorized vehicle that comprises said internal combustion engine”. Yet again, all arguments presented above apply.

The patent publication U.S. Pat. No. 4,304,627 to Lewis John discloses a piston being moved by a laser incited fusion reaction such as deuterium-tritium (D-T) to thereby produce an expandable fusion chamber. When a gaseous substance such as CO₂ is presented in the fusion reaction, it is dissociated into CO and O₂ component mixture and the expansion of the chamber rapidly cools the mixture and quenches the back reaction thereby producing a greater CO yield. Also the piston produces peripheral power from the fusion reaction in the form of mechanical energy. The invention appears to depend on laser-induced fusion reaction (not fission), not yet realized practically with a positive yield mainly due to instability of compression shockwave front observed in inertial confinement. The process also relies on conversion of nuclear fusion energy into chemical energy of a possible CO+O₂ combustion reaction. This chemical reaction appears to integrally accompany the direct conversion into mechanical energy. The expansion of volume is not a smooth dependence but “by means of step function” according to the inventors. The scale of the process does not match the scale of a small modular reactor, since installations employing super-powerful lasers are only a few in the world. Both in its essential features and quantitatively this invention differs from our invention (below), and is not feasible from engineering perspective at this point. No enabling details to make it feasible were provided.

U.S. Pat. No. 6,463,731 to Warren Edward Lawrence also describes a process relying on nuclear reactor coolant heat. The hot nuclear reactor coolant may enter the external combustion cylinder via a heat-exchanger. The heat exchanger is mechanically connected to the valves directing the working fluid's entry and egress from the working cylinder. The heat exchanger can also move within the working cylinder, following the power piston. The power piston receives the expansion energy. The preferred working fluid is air, but any mixes are disclosed. In this scheme the contact between nuclear fuel and working fluid is mediated. It also relies on piston movements for energy conversion. At the same time, the invention comprises moving plunger and heat exchanger in the working cylinder, in addition to the power piston. Combined with often very hot and pressurized primary coolant stream, this aspect raises the issues of safety and reliability. The system calls for sequential heat abstraction form the reactor: first by the coolant and next by the working fluid in the working cylinder, increasing thermal losses. The invention calls on release of spent working fluid in the environment, either limiting the range of acceptable working fluids or requiring an additional cooling, condensing and reprocessing step, plus the pump to operate the extra flow. All these elements would introduce additional costs and differentiate this invention, without limitation, from the proposed herein.

U.S. Pat. No. 7,134,279 to White Maurice A et al. provides an approach that allows for a double-acting, multi-cylinder, thermodynamically resonant, alpha configuration free-piston Stirling system. The system includes overstroke preventers that control extent of piston travel to prevent undesirable consequences of piston travel beyond predetermined limits. The overstroke preventers involve controlled work extraction out of the system or controlled work input into the system. Implementations can also include duplex linear alternators, and/or frequency tuning systems, and/or vibration balancing configurations. The patent appears to disclose application of nuclear energy in this piston-based system, but does not provide any enabling details, specific for nuclear energy utilization.

A list of publications exemplified by JP5256994 assigned to Mitsubishi Heavy Industries Ltd. discloses more applications of Stirling cycle to energy conversion of nuclear sources: EP0625682 to Mundt Jurgen, FR2913458 to Klutchenko Serge, GB1252258, Harry Cooke et al., JP2006057616 to Nagai Masaya, RU2008129555, RU2008141793, RU2349775 to Bolotin Nikolaj Borisovich , US2007186560 to Schuwecker Robert et al., US2009260361 to Prueitt Melvin, U.S. Pat. No. 3,062,000 to Percival Worth H, U.S. Pat. No. 3,117,414 to Farrington Daniels et al., U.S. Pat. No. 3,248,870 to Henri Morgenroth , U.S. Pat. No. 3,250,684 to Dipling Luis et al., U.S. Pat. No. 3,548,589 to Cooke Yarborough et al., U.S. Pat. No. 3,667,215 to Venkataramanayya K Rao et al., U.S. Pat. No. 3,805,527 to Cooke Yarborough et al., U.S. Pat. No. 3,932,792 to Massie Philip et al, U.S. Pat. No. 3,940,932 to Ambrose Robert et al., U.S. Pat. No. 3,971,230 to Fletcher James et al, U.S. Pat. No. 3,984,982 to Hagen Kenneth et al., U.S. Pat. No. 3,986,360 to Hagen Kenneth et al., U.S. Pat. No. 4,004,421 to Cowans Kenneth, U.S. Pat. No. 4,044,558 to Benson Glendon et al., U.S. Pat. No. 4,622,813 to Mitchell Matthew, U.S. Pat. No. 4,996,953 to Buck Erik, U.S. Pat. No. 6,470,679 to Thomas Ertle , U.S. Pat. No. 7,028,473 to Segesser Ludwig et al., U.S. Pat. No. 7,134,279 to White Maurice et al., U.S. Pat. No. 7,603,858 to Bennett Charles, U.S. Pat. No. 7,762,055 to Ide Richard et al., WO08156913 to Bennett Charles, WO10029385 to Cousin Jean.

More generally, Stirling engines possess several useful properties and the proposals to use them in nuclear engineering, especially in spacecraft are numerous. Stirling engines operate on any available heat source, and do not produce emissions, bearings and seals are located on the cold side requiring low maintenance, no valves are needed. A Stirling engine does not use boilers decreasing the risk of steam explosions. Low operating pressure allows the use of lightweight cylinders. Stirling engines can be built to run quietly and are suitable for air-independent propulsion use. They run more efficiently in cold weather, in contrast to the internal combustion which starts quickly in warm weather, but not in cold weather. Waste heat is easily utilized (vs. internal combustion engine) making Stirling engines useful for combined heat and power systems.

On the shortcoming side, Stirling engines display high cost per unit power, low power density and high material costs. Stirling engine requires extensive heat exchangers for heat input and for heat output. The heat input exchangers have to be able to withstand the pressure of the working fluid, where the pressure is proportional to the engine power output. The exchanger on the hot side must resist the heat source, and have low creep deformation. Metallurgical requirements for the heater material are stringent. While in Otto engine the explosive heat release and super-high temperature are very transient and do not damage metal parts, in Stirling heaters the process is continuous. Heat sink requires comparable power to the heater, increasing the size of the radiators, impacting compactness. Heat transfer coefficient of gaseous convection is low, especially on cold side. Power density and power-per-weight ratio decrease as a result. Increasing the temperature differential and/or pressure allows Stirling engines to produce more power, at the price of more expensive heat exchangers and the need to maintain convection. Working cycle of Stirling engine depends on establishing of the thermal difference between the ends and on mechanical piston start-up, this may be a lengthy process. Change of speed or power output can be a challenge for these engines and may require additional mechanisms, although a number of approaches is possible.

Stirling cycle efficiency depends on the speed of heat transfer in turn determined by heat capacity of working fluid molecules. Helium and hydrogen are the gases with minimal heat capacity and highest heat conductance. However, helium is expensive and hydrogen is unsafe at many levels (leaks, metal corrosion, weakening of pressurized vessels). Hydrogen requires a special coating on the engine that is not always practical. Regular air becomes unsafe at high pressures and at hot end. Possibly, nitrogen presents the safest alternative at the price of decreased engine efficiency.

To summarize, we found that some proposed approaches to piston-based nuclear energy conversion are impractical from engineering point of view or not feasible technologically at this point of time. Some publications appear to describe feasible and practical technologies (U.S. Pat. No. 6,463,731, JP5256994 and other Stirling cycle machines), but unnecessary complexity in structure, low power density and low power-per-weight ratio may limit their usefulness. The deficiencies of Stirling cycle create additional motivation to explore other designs for nuclear energy conversion in piston-based systems. Diesel and Otto cycles are used in internal combustion engines for direct conversion of chemical energy into mechanical energy or in case of Diesel cycle into electric energy. Attractive aspects of these systems are high power-per-weight, regulation of power output, compactness. In their power per weight ratio and capital costs these engines have an edge over both turbines and Stirling engines and in terms of power density Diesel engines and steam turbines can compete. A possibility of designing nuclear-driven engines with high power-per-weight ratio and variable power output has technological implications beyond energy production and may be useful in construction of novel submersibles, high-power train locomotives, pilotless airplanes, drilling machines, ore and fossil fuel mining machinery, heavy cross-country vehicles, safe offshore platforms, water processing stations, spacecraft.

Thus, the object of the invention is to address the public need in nuclear-driven compact, powerful, technologically feasible, cheap and safe piston machines.

### SUMMARY OF THE INVENTION

The inventive module comprises a cylinder with a reciprocating piston and opposing ends, one “hot” end of the cylinder houses means of energy production by nuclear fission, fission-fusion hybrid or radioisotope decay. The working body in the cylinder is a gas, a steam, a mist, a gaseous liquid suspension or any other gas-based dispersion capable of moderating (neutron delaying). The reciprocating piston moves in a cycle, approaching to and departing from the heating end of the cylinder. The piston comprises a layer of neutron-reflecting material in parallel with the flat bottom of the cylinder.

The size, geometric proportions, neutron management and fuel load of the heating section of the module are such that criticality conditions are reached only when the heating means are filled with condensed moderator and the piston with the neutron reflecting layer is in substantial proximity to the fuel (heating) section. Alternatively, only approach of the reflecting piston is required to trigger criticality, regardless of the aggregate state of the moderator. In such systems, auto-regulation is achieved and negative feedback is used to control either continuous or pulsing reaction regime.

An advantage of the invented system is high heat transfer coefficient on the heating end due to vigorous convection and high surface of heat exchange between the bubbles of forming steam and yet non-boiling working fluid. High heat transfer rate leads to high rate of power production per volume of the engine.

Still another advantage of the invented system is compactness, all energy producing elements being combined in a single module, with the choice of converting the thermal nuclear energy in either electric or mechanic energy directly, depending on the embodiments.

Yet another advantage is rapid response of the power output to the means of control, such as neutron reflector positioning, setting of the condenser regime, setting of the piston resisting force.

Another advantage of the system is the presence of condensed moderator producing high negative feedback coefficient, increasing inherent safety and enabling self-regulating reactor regimes.

Still another advantage is the closed working fluid circuit preventing radioactive emissions in atmosphere and enabling use of special working fluids with the desired properties.

Yet another advantage is the ability to actuate the system “at will” only when needed, while most of time the system can be in a passive (resting) state in some embodiments.

Still another advantage is the ability to extract useful energy in short powerful pulses, achieving high power-per-mass ratio.

### LIST OF FIGURES AND DEFINITIONS

“Horizontal plane” is defined as the plane parallel to a sector of earth's surface, the curvature is neglected

“vertical direction” or “Z-axis” is defined as a direction perpendicular to horizontal plane, as defined earlier

“Tact” is defined as a movement of the power piston in the same direction from one limiting position to another

FIG. 1A presents the parts of the embodiment 1

FIG. 1B presents the corresponding power piston positions in terms of cycle stages as well as working fluid movements.

FIG. 2A presents the T-S diagram of the proposed cycle

FIG. 2B presents a prior art T-S diagram of Rankin cycle.

FIG. 3A presents the parts of the embodiment 2 and FIG. 3B presents the corresponding power piston positions in terms of cycle stages as well as working fluid movements.

FIG. 4A presents the parts of the embodiment 3 and FIG. 4B presents the corresponding power piston positions in terms of cycle stages as well as working fluid movements.

FIG. 5A presents the parts of the embodiment 4 and FIG. 5B presents the corresponding power piston positions in terms of cycle stages as well as working fluid movements.

FIG. 6A presents the parts of the embodiment 5 and FIG. 6B presents the working process of a cavitational envelope submarine propulsion.

FIG. 7 presents parts and working process for the embodiment 6.

FIG. 8 presents the heater element

### DETAILED DESCRIPTION

### Embodiment 1

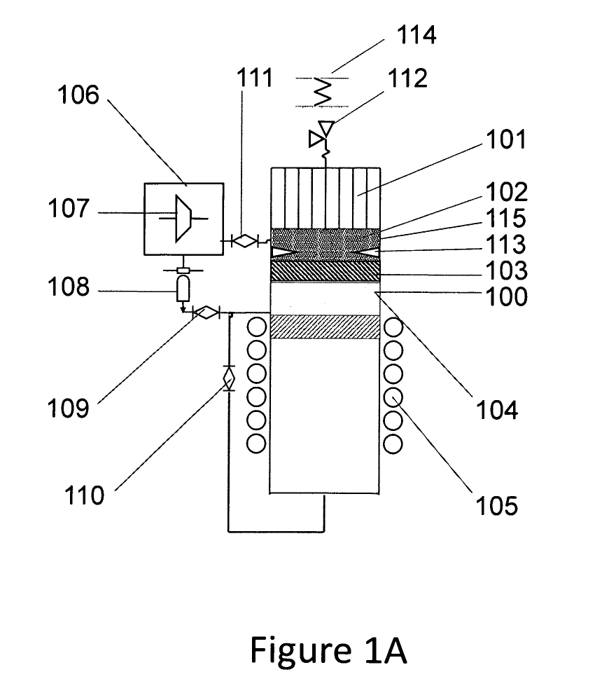

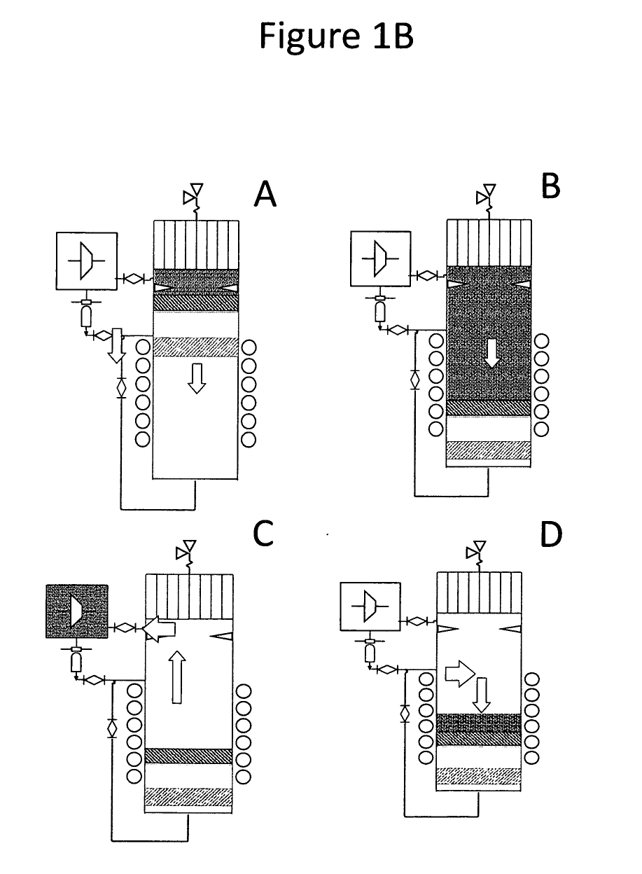

In the embodiment 1 according to FIG. 1A, the system comprises the heating element 101, metallic or ceramic cylinder 100 housing the heating element 101 on its “hot end”, “cold end”, opposite to the hot end, piston 103, beryllium neutron reflectors 104, electromagnetic alternator 105, condenser 106, a turbo-expander 107, fluid accumulator with an optional heat-exchanger 108, an exhaust valve 111, an inlet valve 109, a drain valve 110, a safety valve 112, piston restrictors 113, shock absorbers 114. Other elements known in the art are not shown but will be discussed when necessary. Relative to the direction of gravity force, the heating zone is on the top of the cylinder and the piston approaches it from below to trigger a new cycle. The reason for such orientation of the heaters is thermodynamic efficiency. This parameter will be improved if the entire mass of the condensed moderator is introduced in the heating zone and thus creates a small volume of high pressure steam. Placing of the heating zone on the bottom of the cylinder would lead to the condensate prematurely re-evaporating, adversely impacting the volume ratio of the engine.

The cycle can be described in terms of tacts, defined above. The embodiment 1 comprises a four tact cycle with external condensation of the working fluid. The cycle is triggered by simultaneous proximity of working fluid condensate and neutron-reflecting piston to the fissile fuel elements. The initial position of the piston is the maximal proximity to the “hot end” and the fuel elements are submerged in the working fluid condensate (FIG. 1B, stage A). At this point the system reaches criticality and heat evolves rapidly, evaporating the working fluid. At certain separation from the zone of reaction the concentration of moderator drops and the piston reflector sufficiently departs, stopping the reaction. The working fluid still can be heated by thermal inertia of the “hot” end. Upon reaching the predetermined volume (FIG. 1B, stage B) the working fluid is released in a condenser that can comprise without limitations: a throttle valve, a turbo-expander, a piston expander or a heat-exchanger or any other type of condensers known in the art. At the end of the tact 1 the piston is at the furthest distance from the “hot end” (FIG. 1B, stage B). The exhaust valve 111 opens and the steam enters the condenser (FIG. 1B, stage B ends and stage C begins). The tact 2 starts with reverse movement of the piston 103 form the “cold end” to the “hot end” and proceeds by expelling the residual vapor in the condenser (FIG. 1B, stage C, all movements of the piston are not shown, only its most distal position vs. the heating element is shown). At the end of tact 2 the piston is near the hot end and the entire moderator is expelled in the condenser (FIG. 1B, stage C). The tact 3 starts with the motion of the piston 103 in the direction from the hot to the cold end drawing the working fluid back into the cylinder from the condenser via inlet valve 109 (FIG. 1B, stage D). Drain valve 110 can be optionally used to drain the condensed working fluid from behind the piston, where it can leak through the scratches and surface micro-defects or accumulate by diffusion. At the end of the tact 3 the piston 103 is at the most distal position vs. the hot end (FIG. 1B, stage D). The tact 4 starts with closing the valves 109, 110 and 111. The piston 103 with the condensed moderator laying on its surface (shown in FIG. 1B, stage D) begins to approach the heating element once again and upon filling it with the condensed moderator the reaction re-starts.

The volume covered by the piston 3 is determined by restrictors 113. In some embodiments the mechanical work of a cycle is produced against inertia of a flywheel. In other embodiments the mechanical work is produced against an electromagnetic field of an alternator 105. In still other embodiments the mechanical work is directly passed to moving elements such as propellers, drills, transmissions. These examples do not limit the methods thereby the work directed to power piston can be utilized.

The shock absorbers 114 are utilized to minimize oscillating dynamic forces developing in the assembly as a result of inertia of the parts. The neutron reflecting heat insulation 115 is applied to limit unproductive heat losses during expansion and to minimize overall size of the system. In a preferred embodiment it can be designed instantly removable if the need to stop reaction immediately develops.

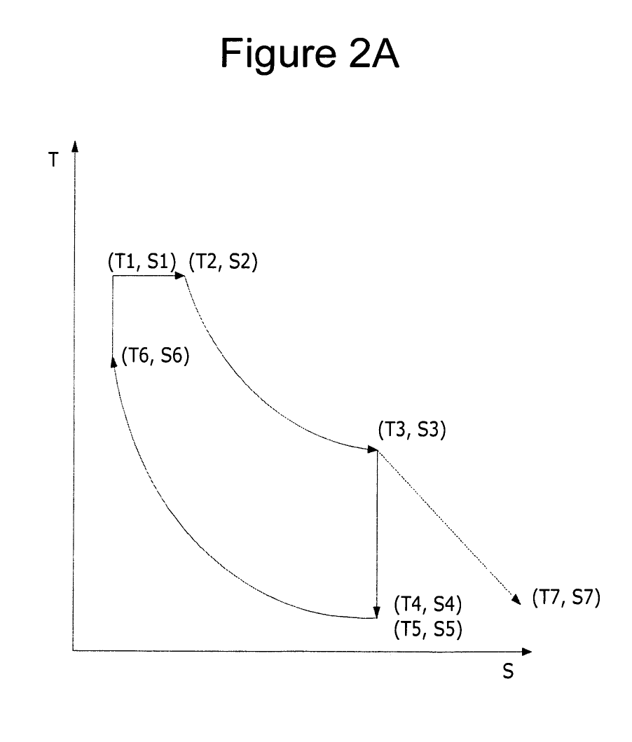

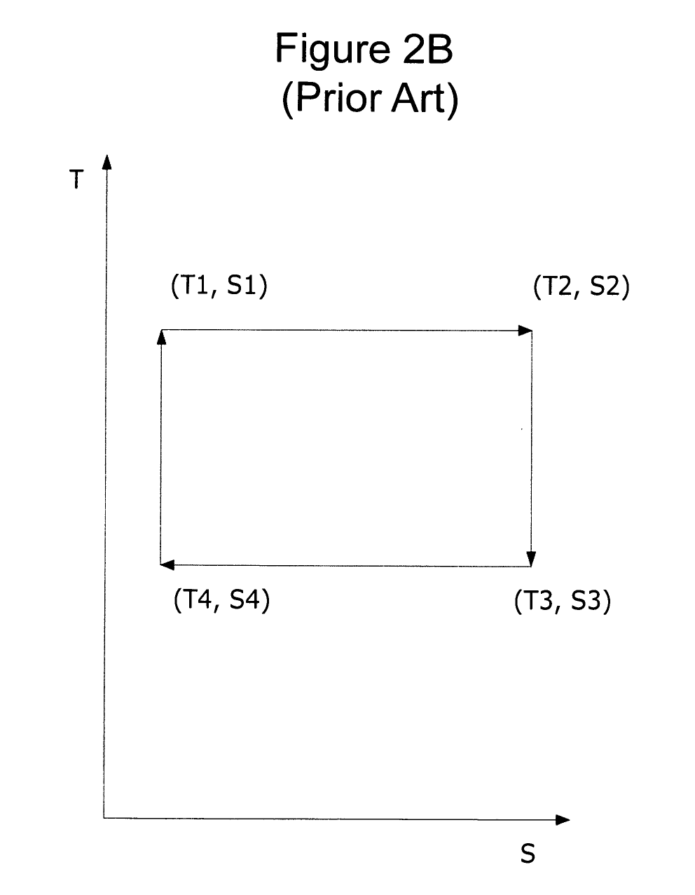

FIG. 2A presents a T-S diagram of the above described cyclic process. At the beginning of the cycle, the piston rests near the heating zone. After starting the reaction, the working heats up, corresponding to a leg from a lower temperature/entropy point (T6, S6) to a higher temperature/entropy point (T1, S1) and then evaporates isothermically to (T2, S2). The fraction of work A1=T2 (S2−S1) is produced by an isobaric process. At this point the piston departs from the heating zone and concentration of moderator falls, stopping the reaction. The working fluid continues to be heated by inertia of the reaction reaching super-heating parameters on T-S diagram and corresponding to the leg (T2,S2)−(T3, S3). During super-heating step the vapor proceeds pushing the power piston, producing the adiabatic expansion component A2 of mechanical work. Upon reaching the point (T3, S3) of the T-S diagram (acceptance of the inertia heat is complete) the steam still expands adiabatically engaging the power piston completing (T3,S3)−(T4, S4) leg of the T-S diagram. The useful work is passed to a converter for conversion into other forms of energy without limitation.

Having reached the maximal separation distance (expansion from T1, S1 to T4, S4) between the piston and the heating section, the pressurized steam enters a condenser. The condenser can be external (the vapor is released into the condenser under its own pressure via valves) or can be internal (the saturated vapor is allowed to proceed expanding, losing pressure, temperature and experiencing progressive condensation as a result). The processes in the condenser can be isenthalpic line T4, S4)−(T7, S7) without abstraction of work or isentropic with abstraction of work A3 corresponding to the triangle (T3, S3)−(T5, S5)−(T7, S7).

After all the steam is substantially condensed the working fluid can be loaded again in the heating zone. The pressure established in the cylinder is the equilibrium pressure with the working fluid after condensation. Upon condensation, piston begins to compress the de-pressurized gas adiabatically, returning the system to the initial state on the T-S diagram, completing the leg (T6, S6)−(T1, S1) of the T-S diagram. In the process the concentration of moderator in the heating zone increases again. The piston approaches the heating section once more and the reaction re-ignites, evaporating and optionally overheating the working fluid and starting another cycle.

One advantage of the invented system is high thermodynamic efficiency of the cycle. In fact, this is a reverse vapor-compression refrigeration cycle resembling Rankin cycle with superheat. At the same time the proposed cycle differs from Rankin's by introducing the isoentropic step (T3, S3)−(T5, S5). Due to continuous expansion with abstraction of additional work the latent heat of condensation is usefully harvested instead of being wasted in an alternative isothermal step (T3, S3)−(T7, S7). FIG. 2B presents a prior art Rankine cycle and the difference in the area of the area between (T1,S1−T4,S4) in FIG. 2B and the area (T1, S1−T6, S6) in FIG. 2A corresponds to the added efficiency of the proposed cycle.

### Embodiment 2

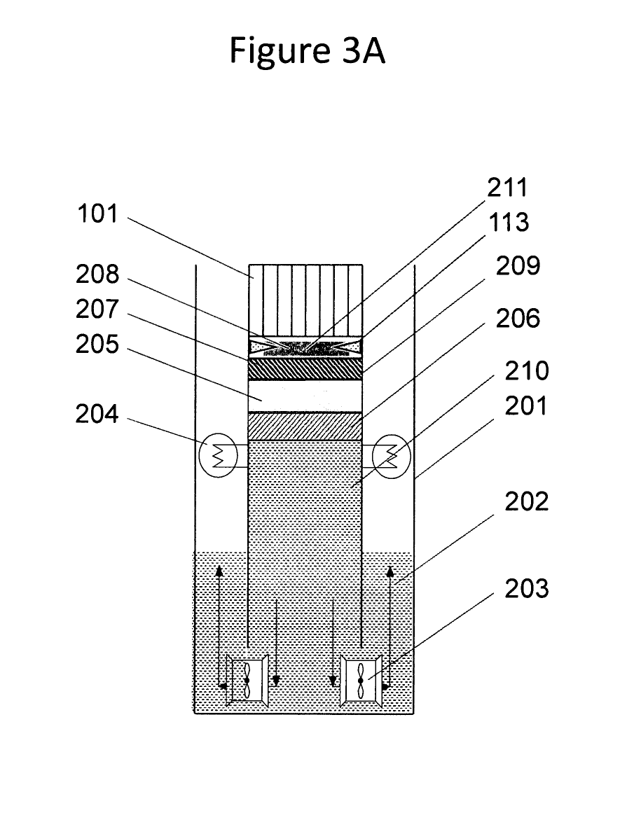

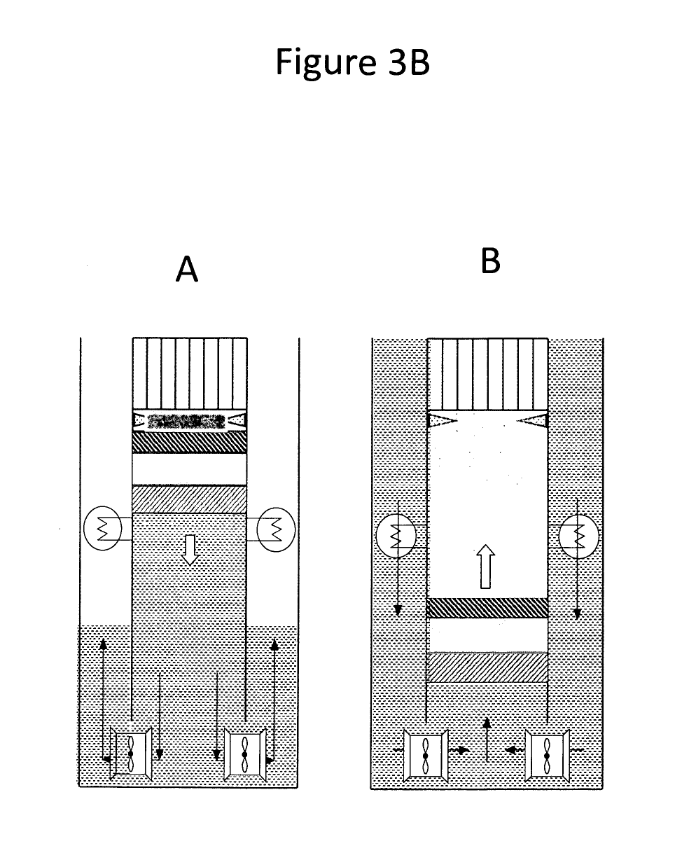

FIG. 3.A presents the parts of the embodiment 2. 101 is the nuclear heat source, 209 is inner reaction vessel, 208 is working space, occupied by vapors of the water-immiscible working fluid (pentane, butane), condenser 204. The parts 205, 206, 207 are parts of a low-density floating piston, lighter than water 210 but heavier than working fluid 211, with a layer of neutron reflector 207 built in and located in horizontal plane, 205 being a heat-insulating light-weight material and 206 being a structural plate. 203 is a hydraulic turbine, 201 is an annular reservoir, a ceramic water impervious construct coaxial and in hydraulic contact with 209.

The gas expansion caused by the evaporation brings into motion a column of water through a hydraulic turbine (FIG. 3B, stage A). The turbine is rotated again when the evaporated steam is condensed and the water levels off, taking the starting position (FIG. 3B, stage B). The attractive side of the process is its simplicity, and economy. Hydraulic turbines are known for their extremely high mechanical conversion efficiency, reaching>92% for Pelton turbines.

The cycle starts with the floating piston compressing the organic layer and pressing it into the nuclear heater (FIG. 3B, stage A), corresponding to the minimal distance between the piston and the hot end. In the presence of the condensed moderator the heater assembly becomes critical. The working fluid is evaporated and the gaseous front presses on the piston 205-207 in the zone 208. By movement of the piston, the water is being displaced from the vessel 209 by expansion of the gas in the zone 208 and in the process rotates the hydraulic turbines 203. The turbines are connected to the means of energy conversion without limitation. Having passed the turbines, the water accumulates in the annular ceramic reservoir 201 (FIG. 3B, stage B). The “bubble” of gas stays in the space 208 for an optimal time interval that can be determined by optimization analysis known in the art. The heat-insulating ceramic foam material 205 of the piston and the cermet walls of 209 enable delayed cooling of the gas bubble in 208 allowing mechanical work production. At some point, the exhaust valve (not shown) opens and the compressed hydrocarbon vapor enters a condenser 204, located in the annular space 201. The falling water level in 201 passes through the condenser, facilitating heat exchange. The volume 208 decreases and the water stored in 201 flows through the turbines 203 back into the space 201. The engine of the embodiment 2 is two-tact, producing energy in each.

FIG. 3.B represents even more compact version of the embodiment 2. The exhaust and inlet valves are omitted, instead the metal wall of the vessel 209 is in contact with the water in the annular reservoir 201. As the piston stroke progresses, the water level increases in 201, increasing heat exchange coefficient on the wall 209 (water cooling instead of air cooling). Since the initial expansion is the most thermodynamically efficient in producing useful work by the cycle, the heat exchange at this stage is metal-air. At a later stage (corresponding to the piston's most distal position from the hot end, prior to the return thrust of the piston) the walls of the cylinder are cooled by the rising water level. As a result, a significant portion of the working fluid is condensed and the working cycle ensures.

### Embodiment 3

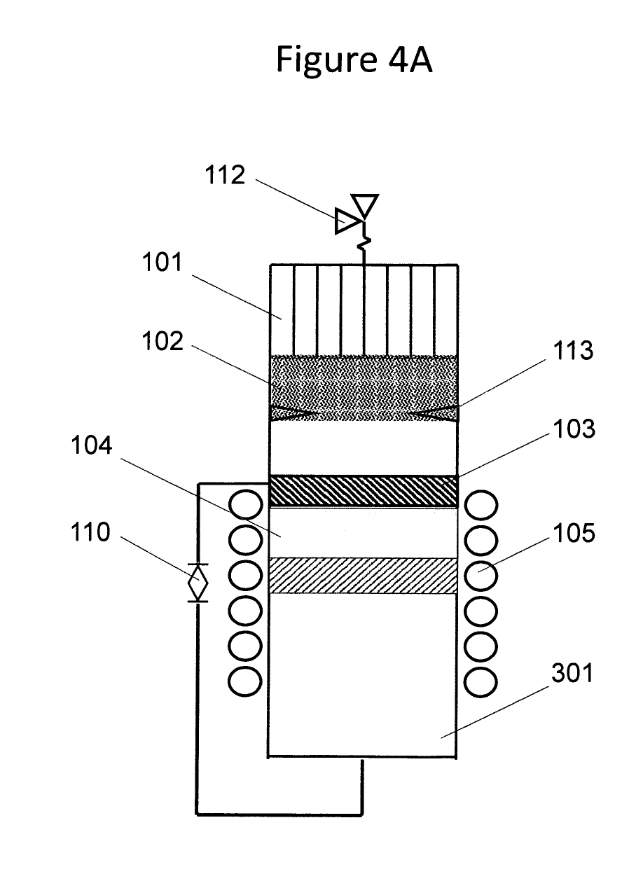

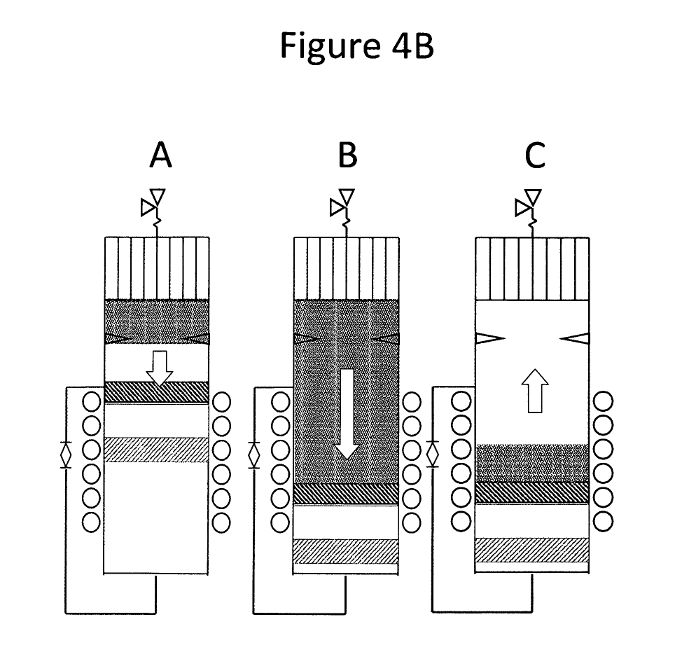

FIG. 4A shows the parts of the embodiment 3 also termed “steam gun”. In this approach the system comprises (FIG. 4A) the heating element 101, metallic or ceramic cylinder 100 housing the heating element 101 on its “hot end”, “cold end”, opposite to the hot end, piston 103, beryllium neutron reflectors 104, electromagnetic alternator 105, a drain valve 110, a safety valve 112, piston restrictors 113, shock absorbers 114. Other elements known in the art are not shown but will be discussed when necessary. Relative to the direction of gravity force, the heating zone is on the top of the cylinder and the piston approaches it from below to trigger a new cycle. The element 301 (condensation space) differentiates this embodiment with the embodiment 1 as well as the absence of the valves 109 and 110. The gas expansion proceeds in four steps: a) evaporation of working fluid b) overheating c) adiabatic expansion until saturation d) isentropic expansion of the saturated vapor in the same cylinder. The saturated vapor of the working fluid continues to produce useful work, while expanding and condensing isentropically (FIG. 4B, stages A and B). The length of the condensation space 301 is sufficient to ensure condensation of a significant proportion of the working fluid, in the range between 0% and essentially 100%. The condensate accumulates on the piston under the force of gravity and fills the heating element at once when the piston approaches the hot end (FIG. 4B, stage C). To enable significant expansion under the conditions of diminishing vapor phase enthalpy in 301, the means providing for the piston's resistance can be set to produce a profiled, variable or diminishing resisting force or dwelling regime in some embodiments without limitation. The expansion processes comprise the first tact (FIG. 4B, stages A and B. During the second tact the partially condensed and chilled working fluid is compressed adiabatically (FIG. 4B, stage C).

### Embodiment 4

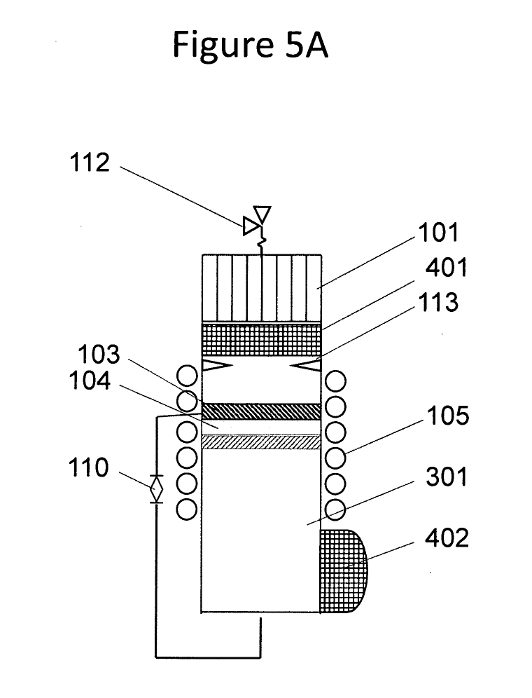

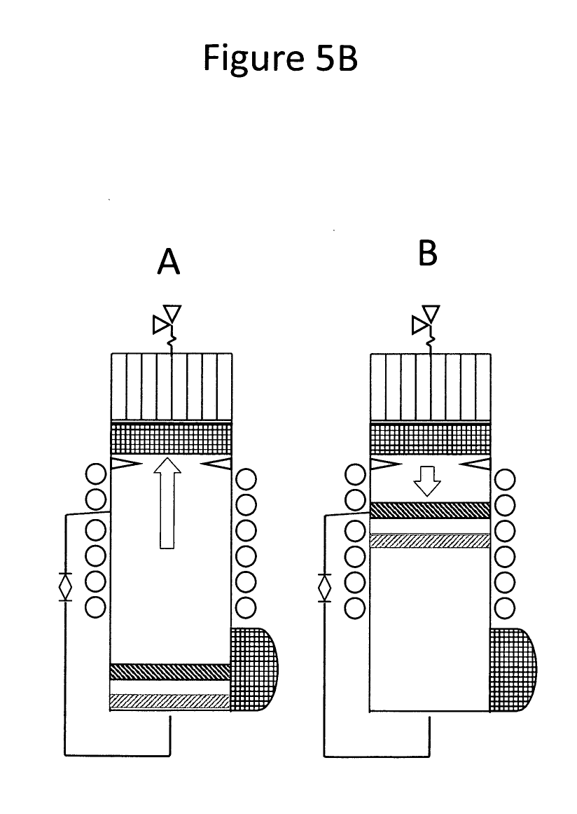

FIG. 5A presents the parts of the embodiment 4. The parts comprise the heating element 101, metallic or ceramic cylinder 100 housing the heating element 101 on its “hot end”, “cold end”, opposite to the hot end, piston 103, beryllium neutron reflectors 104, electromagnetic alternator 105, a drain valve 110, a safety valve 112, piston restrictors 113, shock absorbers 114 (not shown), expansion space 301, heat exchange facilitators 401 and 402. Optionally, the side walls proximal to the hot end can be wrapped into flat thermo-couple ribbon elements 403, to achieve both heat insulation and waste-heat conversion into electric energy.

In this embodiment the working fluid is preferentially nitrogen or a noble gas and phase transition is not envisaged. The heating process is actuated by approach of the piston 103 to the hot end, but condensation of a moderating working fluid is omitted. In fact, the parameters of the process are designed to be regulated solely by the approach of the neutron-reflecting layer of the piston and not by a combination of the latter with moderator condensation. The piston 103 bears heat insulating layer and graphite-berillum neutron reflecting layer 104. The heater is provided with an extended metallic surface 401 to facilitate heat exchange by the methods known in the art and incorporated herein by reference. The piston compresses the working fluid in the spaces between the elements of the extended heat-exchanging surface.

In first tact, upon approach of the neutron reflecting piston 103 to the hot end 101 the reaction starts and the working fluid expands pushing the power piston. The valve 110 is closed. The piston is a part of an electromagnetic alternator 105, where mechanical energy converts into electromagnetic energy. Upon completing adiabatic expansion the working fluid is cooled by contact with heat conducting walls of the cylinder and by giving away energy through mechanical work. The wall extensions 402 are provided to facilitate heat exchange on the cold end. In tact 2 the working fluid gets compressed. At this point, the valve 110 can optionally be opened to facilitate shifting of the cooled gas to the heater. The energy required for the compression in tact 2 is adiabatic work of compression only. The energy that the working fluid possesses during expansion in tact 1 is the sum of the stored adiabatic compression energy plus the increment received during activation of the heating element. The difference forms the useful work of the cycle.

### Embodiment 5

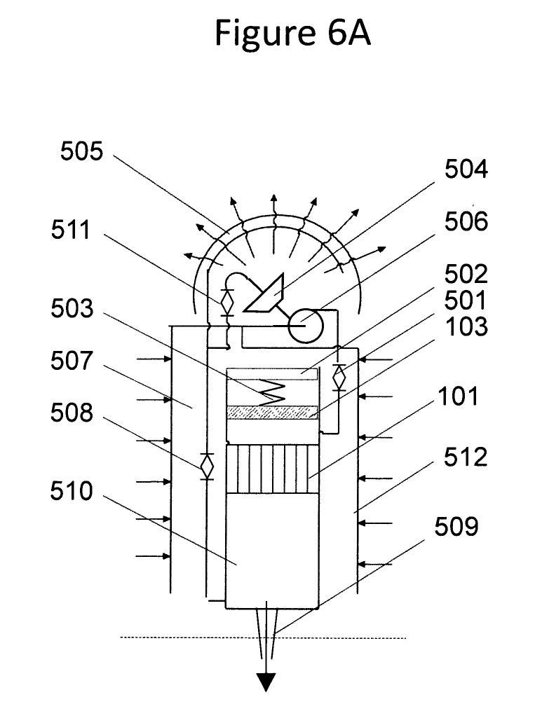

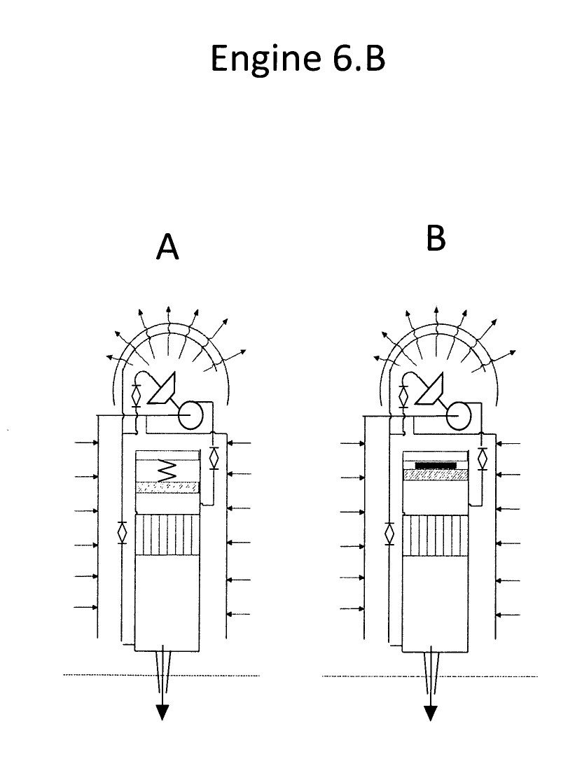

FIG. 6A presents the parts of the embodiment 5 intended for submarine propulsion. The parts comprise heating element 101, neutron reflecting piston element 103, resilient spring element 503, compression chamber 510, nozzle 509, water injection valve 501, steam turbine 504, water pump 506, steam exhaust valve 508, steam diverting valve 511, water intake system 512, frontal steam exhaust system 505.

Operation of the propulsion system takes place in a continuous mode. Water is being pumped by 506 through the heating element 101, achieving partial evaporation. Residual liquid phase is retained to extract the salts that may hinder heat transfer. The proposed fraction of the evaporating water is in the range between 20 and 70%. The pressure builds up and the piston carrying the neutron reflector 103 is pushed against the resilient spring element 503. The increasing distance provides auto-regulation. The water-steam foam produces thrust via the nozzle 509 propelling the apparatus. A fraction of the steam-water foam is diverted via the valve 508 into the frontal steam exhaust system 505. The steam emerges under pressure to produce a gas envelope in the zone of the maximal drag and minimizes the latter, enabling faster propulsion. Similar principle wee realized earlier in “supercavitational torpedoes”, such as “Shkval” system, produced by former Soviet Union. The valve 511 is used to divert a fraction of the steam flow to bring into motion the suction pump 506. The pump draws water in through the system 512.

The most important advantage of the propulsion system is its resource of energy enabling rapid underwater propulsion over extensive distances, enabling submarine circumnavigation at torpedo speed. This is in contrast with the 7-9 mile range of “Shkval” system and may produce qualitative impact.

### Embodiment 6

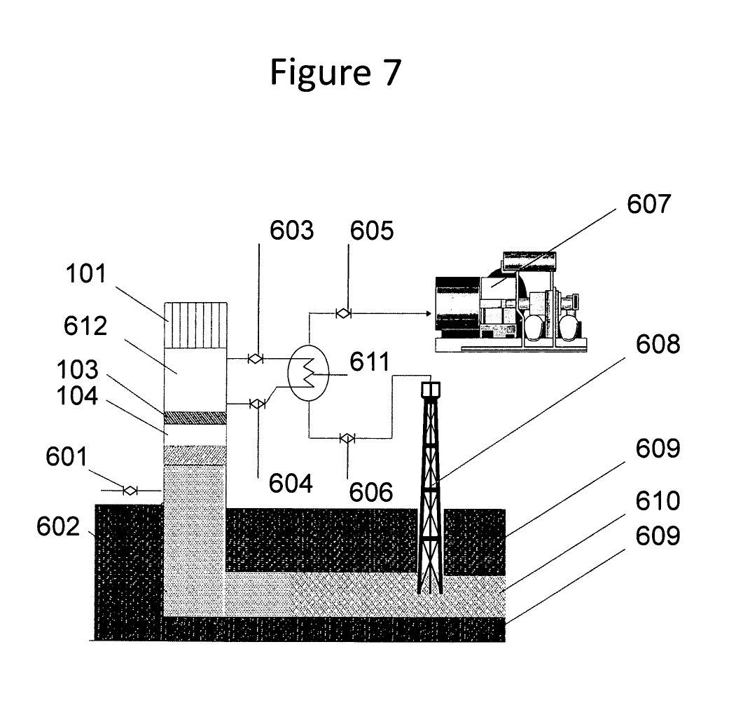

FIG. 7 presents parts used in embodiment 6. The embodiment discloses a system of sub-terrain pressure production, used for expulsion of oil, gas and ore chemical etching fluids from the corresponding deposits. The system comprises heat element 101, hollow piston 104 with neutron-reflecting layer 103, liquid piston fluid 602, inlet valve 601 for liquid piston replenishing, the position 610 symbolizes oil and 608 symbolizes oil tower. The position 609 indicates the terrain layers. The position 612 indicates the working fluid evaporated by the heat element, 611 is the condenser, 603 and 604 are correspondingly inlet and outlet valves for the circulating working fluid, 606 and 605 are correspondingly inlet and outlet valves for the petroleum, serving as a heat sink. The position 607 indicates oil refinery module. The working of the system is similar to the embodiment 2: upon approaching of the heating element 101 by the neutron reflector 103 the reaction becomes critical. The expanding working fluid presses upon the hollow piston 104 floating on the liquid piston 602 and the latter passes the pressure to the oil deposit. The escaping oil passes though the condenser 611 and accepts the waste heat released by compressed evaporated working fluid, entering the condenser via valve 603. The heated oil enters the rectification column or any other petroleum processing equipment without limitation.

The most important advantage of the process is a simple nuclear-fueled installation to enhance processing of depleted or poor mineral and fossil deposits. Both useful work and heat can be utilized usefully.

### Heating Elements

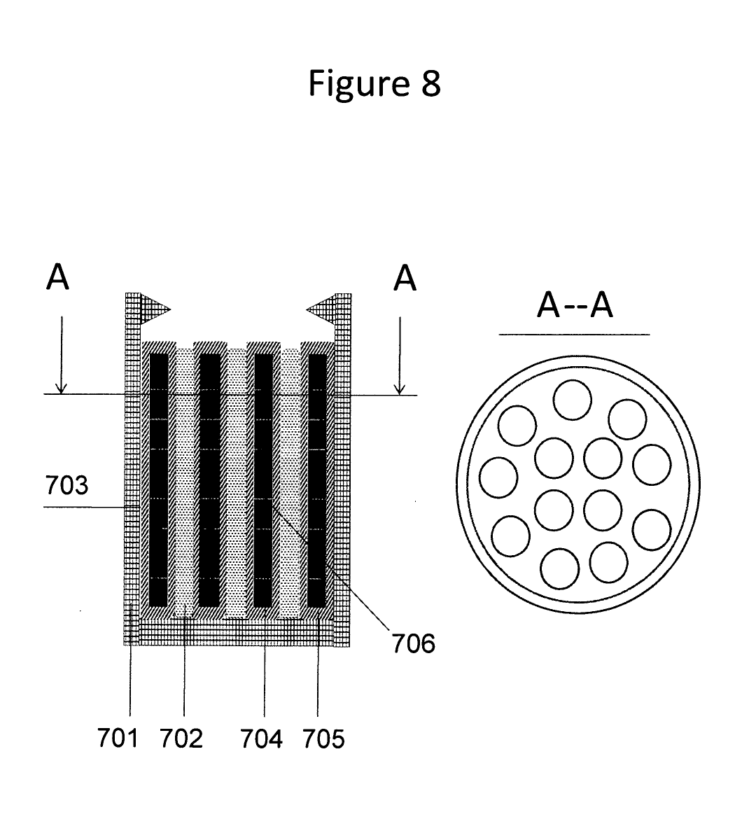

All embodiments comprise heating elements that can be standard and well known to the skilled in the art. FIG. 8 presents the typical parts of a heating element. Appropriate known designs are incorporated herein by reference. In a preferred embodiment, such a design comprises standard fuel rods 705, filled with MOX fuel or metal nitride fuel or metal carbide fuel or metal fuel 704. The casings of the rods are performed of Zircalloy to ensure neutron transparency. A metal plate with “finger-like” protrusions 706 serves as a ceiling of the working cylinder in embodiments 1-4. The space 702 between the protrusions can be filled with liquefied moderator (FIG. 7A). The section A-A shows the view of the heating element in the horizontal plane XOY (parallel to the ground).

### Working Fluid

In general, any volatile, non-corrosive and neutron moderating fluid can serve as a working fluid of the invention. The most preferred working fluid has to comply with a number of additional requirements:
a) The fluid must be “wet” in terms of T-S diagram behavior. Specifically, expansion of saturated steam of such a fluid should lead to condensation.
b) The fluid should be chemically stable and do not experience thermal decomposition, cracking or radiolysis too easily.
c) The fluid should not be too high or too low boiling.
   Review of existing heat carriers and cryogenic fluids established water, n-butane, isobutene, n-pentane, iso-pentane, neopentane, hexane isomers and any mixes thereof as the most preferred group of working fluids complying with all above-listed requirements. Deuterated and tritiated analogues of water and the above-listed alkanes are conceivable with possibly superior moderating and neutronic properties, well known in the art. As a reasonable alternative, use of alcohols is acceptable.

### Condensers

In general, any type of a condenser is applicable without limitations. The embodiments include throttle valve, turbo-expander, piston-expander, air-cooled heat-exchanger, water cooled heat-exchanger, a sprinkler and other systems known in the art.

Known prior art systems of working fluid condensation are incorporated herein by reference. Non-limiting examples of the systems that may be incorporated are the systems of U.S. Pat. No. 4,276,747 and GB2010974 that disclose recuperation of thermal energy of exhaust gases of heat engines by evaporating a working fluid, expanding the steam while performing mechanical work and condensing the steam, producing a cycle. U.S. Pat. No. 7,392,796 claims an internal combustion engine, wherein chemical components of the exhaust gases undergo an aggregative-phase transition, and producing a vacuum in the closed volume of the single thermodynamic system to produce an additional positive power stroke in the expansion chamber of the internal combustion engine, as a vacuum engine. The specific type of equipment used as a condenser in the system, relying on a Ranque effect is incorporated herein by reference.

### Construction Materials

The inventive system presents challenges of combined dynamic load of parts, oscillating temperature gradients, radiation damage, radiolysis product accumulation and damage by these products. The materials are expected to function in the regimes comparable to the regimes in turbines and aviation engines. The preferred materials for such purposes are tungsten alloys, Superalloys without limitations, and specialty steels for the embodiment 2 presenting less challenging conditions. Without limitations all other alloys or cermets known in the art can be incorporated herein by reference: titanium alloys, niobium alloys, tantalum alloys, chromium alloys, vanadium and zirconium alloys. Especially preferred are zirconium alloys.

### Vibration Dampers

The dynamic forces developing as a result of part's movement can be minimized by placing the assembly between metal spring supports, providing shock absorbing (element 114 in embodiment 1). Other methods of shock absorption known in the art are incorporated herein by reference. These methods comprise but are not limited to dry friction shock absorbers, fluid friction shock absorbers, material hysteresis shock absorbers, chain shock absorbers, pneumatic (air compression) shock absorbers, hydraulic dashpots, magnetic resistance devices, inertial resistance devices, hydropneumatic shock absorbers. Most preferred are spring-based and pneumatic based shock absorbers that allow converting of the absorbed energy into useful forms.

### Piston Lubrication and Liquid Pistons

Safe and productive functioning of the system depends of smooth movement of the power piston in the working cylinder, requiring lubrication. One method of providing reliable lubrication is graphite suspension in the working fluid, acceptable for water and hydrocarbon working fluids. Molibdenum and tungsten sulfides are acceptable materials for hydrocarbon working fluids, but hydrolysis in pressurized water steam environment may limit use of these dry lubricants in embodiments 1, 3 and 4. A fundamental approach to solve the problems of piston friction is to use liquid piston, as in the embodiment 2. Other suitable methods known in the art for enabling sufficient lubrication under the conditions of heavy mechanical load and high temperatures are incorporated herein by reference.

### Methods of Producing Resisting Force

Several methods are known in the art to accept the energy passed to a power piston: a flywheel with a crankshaft, inertia of displaced working body, resilient force of a pneumatic reservoir, the energy of electromagnetic field and other methods known to the skilled in the art without limitations and incorporated herein by reference. The resistive force can be of any profile in space and time, oscillating alternating, constant, decreasing with the progression of the piston stroke, increasing with the progressing of the piston's stroke, all embodiments known in the art are incorporated herein by reference. As an exemplary embodiment, a piston may comprise a ferromagnetic component that would experience repulsive force from a powerful solenoid with an electric current. Upon pushing of the ferromagnetic in the solenoid, work against magnetic field is produced that would result in the increased electric current or voltage in the circuit feeding the solenoid. Such an increase can be transformed in an additional power returned in the electric grid.

### Safety Features

While pulsed reaction system demonstrates high negative temperature coefficient, it is not completely inherently safe. A possibility of mechanical failure may delay the piston near the heating zone, preventing stopping of the reaction by decreasing the moderator density and departure of the neutron reflector. Other means of stopping reaction should be provided. Herein the invention incorporates by reference known means of urgent gas evacuation and pressure control: electrically actuated valves, mechanically actuated valves, safety perforation diaphragms. Other means refer to fission reaction control: spring actuated removal of neutron reflectors, injection of neutron absorbing solution and other known methods of nuclear reaction control incorporated herein by reference. In the most preferred embodiments the safety features of the assembly should comprise a combination of electrically and mechanically actuated means, and not rely on electric means exclusively. A back-up autonomous electric energy accumulator is a part of the preferred safety system embodiment, in case of losing contact with electric grid.

Still another safety aspect is radiolysis of water-based working fluid, producing oxygen/hydrogen mix. Uncontrolled accumulation of such a mix can produce a danger of an internal explosion and structural damage. In addition, accelerated metal cracking may develop in the presence of compressed hydrogen. The concentration of oxygen/hydrogen can be controlled by any method known in the art for these purposes including but not limited to: catalytic oxidation in the working cylinder, catalytic oxidation outside the cylinder, venting in the atmosphere, venting in an absorbent bed. The step of oxygen/hydrogen mix removal can be automatic or can be operator-controlled without limitations, automatic control being a preferred embodiment.

Still another safety aspect is radiolysis of hydrocarbon working fluids, producing soot deposits on heat exchanging surfaces and hydrogen gas. Soot accumulation can lead to decreased thermodynamic efficiency, while hydrogen can lead to metal cracking. The soot accumulation can be countered by using of dispersants, keeping the soot in the solution and hydrogen can be periodically removed by post-condensation venting. These applications are not limiting and any other methods of soot removal from heat exchanging surfaces known in the art are incorporated herein by reference.

### Applications to Pulsed Energy Production

Pulsed energy producing systems may possess qualities distinct from continuous energy production systems. In the context of using nuclear energy, it is valuable to utilize the useful energy in a diversity of forms, at the frequency of the piston motions. Typically in conventional schemes the speed of turbine rotation is high and the energy output is electrically mediated. In case of piston applications the forms of output power can be (without limitations): reciprocating mechanical motions of any frequency, torque mechanical motions of any frequency, reactive motion of working body, electric energy of any frequency.

Reactive engines for marine propulsion (embodiment 5) can be built that do not require electric energy and may using the column of water/steam as a thrust-creating body. The sea water can be evaporated and the exhaust steam can be directed toward creating a gas bubble around the vessel, decreasing its drag. Condensation of steam bubbles would make the passage of a submersible vessel invisible from the surface. The gas flow from the engine incorporates by reference the engineering solutions applied in super-cavitating marine propulsion systems.

Embodiments 1-4 and 6 can be used to create high pressure bursts. The pressure can be passed downstream through the system of valves to a working fluid used for compression chasing oil/natural gas out of the poor deposits.

Embodiment 2 can be used for nuclear energy production using inexpensive materials. The only part of the assembly that requires refractory construction materials is the heating zone. The module comprises a simple and compact design, allowing economy in construction and service costs. Decreasing the costs of energy production allows using of the fissile fuels not viable economically in conventional schemes: recycled fuels, fuels extracted from poor ores, fuels extracted from marine sources and other similar examples without limitations. Uranium is distributed in nature by a logarithmic law: per an order of magnitude decline in concentration, the abundance increases 300 fold. The actual content of uranium and thorium in the earth crust and oceans is significant and its full potential energy content compares with the energy content associated with deuterium fusion. It is the cost of extraction that makes these resources unavailable. Simplification of the energy extraction step, achieved by this inventive technology makes these resources available to a greater extent by shifting the economic margins of profitability.

Embodiments 1, 3 and 4 can be used for production of electric power and for direct mechanical movement. Embodiment 3 in combination with powerful alternators is capable of generating frequent and repeated electromagnetic power pulses. These pulses can charge super-capacitors or be fed directly to different pulse devices: lasers, electromagnetic and microwave radiation emitters, particle accelerators, infrasonic and ultrasonic emitters, jammers, electromagnetic launchers. Most efficient use of such installations is on board of marine vessels where the flow of water provides abundant coolant to provide heat sink to the working cylinder.

1. A method of converting fissile nuclear energy into useful work, comprising the steps of:
a) Providing heating means operating based on a fissile nuclear process;
b) Actuating the said means in a self-regulating pulsed manner by an approach of a piston comprising a neutron reflecting material, producing pressure on the piston proportional to the reaction rate, so that the prompt chain supercritical reaction ceases or diminishes when reflecting piston departs;
c) Initiating upon said actuation a thermodynamic cycle in a piston-based cylinder comprising in sequence: adiabatic expansion of working fluid vapor, isobaric exhaust of the working fluid with subsequent or simultaneous cooling, Intake of the cooled fluid, adiabatic compression of the working fluid until the initial state of working fluid is reached;
d) Using the energy given off during said expansion processes to generate useful work.

2. A method of claim 1, wherein the neutron reflecting piston comprises berillum and graphite.

3. A method of claim 1, wherein the working fluid is: nitrogen, argon, neon, helium, hydrogen, methane, ammonia, water, carbon dioxide and perfluorocarbons, individually or in any combinations.

4. A method of converting fissile nuclear energy into useful work, comprising the steps of:
a) Providing heating means operating based on a fissile nuclear process;
b) Actuating the said means in a self-regulating pulsed manner by a combination of primary working fluid condensate placement in the heating means and approach of a piston comprising a neutron reflecting material to the heating means, so that the prompt chain supercritical reaction ceases when a fraction of working fluid evaporates or reflecting piston departs or both, the said fraction being in the range between 0.2 and 1.0;
c) Initiating upon said actuation a thermodynamic cycle in a piston-based cylinder comprising isobaric expansion of evaporating working fluid, adiabatic expansion of superheated working fluid vapor, isentropic expansion of saturated working fluid vapor, condensation of essentially entire amount of the working fluid, adiabatic compression of the working fluid and its saturated vapor until the initial state of working fluid is reached;
d) Using the energy given off during said expansion processes to generate useful work.

5. The method of claim 4 wherein the working fluid is water, hydrocarbons, fluorinated and perfluorinated hydrocarbons, alcohols, CO2, ketones, ethers, esters, ammonia individually or in any combination.

6. The method of claim 5 where the protium hydrogen is replaced by deuterium.

7. The method of claim 6 wherein the working fluid comprises light water (protium oxide), half-deuterated water (deuterium-protium oxide), deuterated water (deuterium oxide), deuterium-tritium oxide, tritium-protium oxide, tritium oxide, ethanol, deuterated ethanol, tritiatd ethanol, propanol and isopropanol.

8. The method of claim 5 wherein the working fluid is the group consisting of linear butane, isobutane, tertirary butane, linear pentane, branched pentanes, cyclopentane, linear hexane, branched hexanes and cyclohexane.

9. The method of claim 4 wherein the isentropic expansion step and working fluid condensation are combined in a condenser.

10. The method of claim 9 wherein the condenser is an expander based on Joule-Thompson thermal effect.

11. The method of claim 9 wherein the condenser is a cylindrical extension of the working cylinder housing the heating means, the step of isobaric expansion, the step of adiabatic expansion, the step of isentropic expansion and the step of adiabatic compression of saturated working fluid vapor, the diameters of the extension and of the remaining part of the cylinder being equal.

12. The method of claim 4 wherein the expansion energy of the working fluid is applied to producing a difference between depressed and elevated water levels in the corresponding reservoirs, the water level differential being subsequently utilized.

13. The method of claim 12 wherein the said water level differential is utilized in rotation of a hydraulic turbine by allowing the said differential to equalize.

14. The method of claim 12 wherein the power piston is at least in part is a liquid piston.

15. The method of claim 1 wherein the self-regulating reactors of this invention are used in the processes of: mining of solid minerals, mining production of oil, mining production of non-oil fossil fuels, drilling exploration of sea bed, ground drilling operations on dry surface, sea water desalination, fluid pumping, energy production, marine propulsion, submersible propulsion, rail propulsion, non-rail propulsion on dry surface, river water propulsion, space propulsion, space energy production, residential heating, energy provision of military bases, unmanned flight propulsion, pulse production of energy for lasers, pulse production of energy for particle accelerators, pulse production of energy for projectile launching.

16. The method of claim 4 wherein the self-regulating reactors of this invention are used in the processes of: mining of solid minerals, mining production of oil, mining production of non-oil fossil fuels, drilling exploration of sea bed, ground drilling operations on dry surface, sea water desalination, fluid pumping, energy production, marine propulsion, submersible propulsion, rail propulsion, non-rail propulsion on dry surface, river water propulsion, space propulsion, space energy production, residential heating, energy provision of military bases, unmanned flight propulsion, pulse production of energy for lasers, pulse production of energy for particle accelerators, pulse production of energy for projectile launching.

17. The method for marine propulsion comprising the steps of:
a) Triggering a nuclear prompt reaction by a neutron-reflecting piston approaching a heating zone;
b) Partially evaporating water in the heating zone comprising a pressure chamber;
c) Steam pressure building up in said pressure chamber is released through a nozzle on the end opposite to the heating end producing reactive thrust;
d) Steam pressure acting on said piston attached to a resilient means and pushing it away from the heating zone thus producing a steady regulated reaction;
e) Diverting a fraction of the steam flow from the pressure chamber to the boundary between the moving marine vessel and water so that the drag force acting on the moving vessel is decreased;
f) Diverting a fraction of the steam flow from the pressure chamber to a water pump, supplying water to the heating zone via the pump and maintaining continuity of the propulsion process.
